(19) United States
(12) Patent Application Publication
(10) Pub. No.: US 2025/0315722 A1
(43) Pub. Date: Oct. 9, 2025

(54) SYSTEMS AND METHODS FOR AUGMENTING FEATURE SELECTION USING FEATURE INTERACTIONS FROM A PRELIMINARY FEATURE SET

(71) Applicant: Capital One Services, LLC, McLean, VA (US)

(72) Inventors: Zhen HOU, McLean, VA (US); Ruoyu SHAO, Allen, TX (US)

(73) Assignee: Capital One Services, LLC, McLean, VA (US)

(21) Appl. No.: 18/629,664

(22) Filed: Apr. 8, 2024

(51) Int. Cl. G06N 20/00

(52) U.S. Cl. CPC G06N 20/00

(57) ABSTRACT

Systems and methods for augmenting feature selection for a first machine learning model using feature interactions from a preliminary feature set used for a second model. In some aspects, the system receives a first candidate set of features to train a machine learning model. The system also receives a precursor feature set used to train a precursor machine learning model in preparation for the machine learning model. Using the first candidate set of features and the precursor feature set, the system trains an algorithm to produce an interaction matrix, wherein the interaction matrix indicates an explanative power of each feature when combined with other features. Based on the interaction matrix, the system generates a subset of features from the first candidate set of features and the precursor feature set using a selection program. The system thus trains the machine learning model to use the subset of features as input.

### SUMMARY

Methods and systems are described herein for novel uses and/or improvements to artificial intelligence applications. As one example, methods and systems are described herein for using interactions between features of an early-stage machine learning model and candidate features of a late-stage model to inform feature selection for the late-stage model.

Conventional systems for multi-stage machine learning model development lack a reliable method for using the insights regarding feature importance from a previous stage to aid the development of a later-stage model. Conventional systems especially struggle in cases where features cannot be transferred over from an earlier stage to a later stage. Conventional systems typically initiate the feature selection process from scratch for each stage, causing unnecessary delays in model development and possibly suboptimal feature choices.

By contrast, the systems and methods described herein leverage feature interactions across model development stages to inform the feature choices for a later stage model. For example, the system computes an interaction matrix between precursor features from an early-stage model and candidate features for the late-stage model. Doing so allows the system to lean on powerful features from the early-stage model to improve the predictive power of the late-stage model, especially in contexts where features are not directly translatable from the early stage to the late stage. While performing conventional feature selection is inefficient in time and computing resources, the system and methods herein provide an expedient and accurate means of selecting high-quality features to create a reliable machine learning model.

In some aspects, methods and systems are described herein for augmenting feature selection for a first machine learning model using feature interactions from a preliminary feature set used for a second model, comprising: receiving a first candidate set of features to train a machine learning model, wherein the machine learning model uses one or more of the first candidate set of features as input; receiving a precursor feature set, wherein the precursor feature set is used to train a precursor machine learning model in preparation for the machine learning model; using the first candidate set of features and the precursor feature set, training an algorithm to produce an interaction matrix, wherein the interaction matrix indicates an explanative power of each feature when combined with other features; based on the interaction matrix, generating a subset of features from the first candidate set of features and the precursor feature set using a selection program; and training the machine learning model to use the subset of features as input.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for augmenting feature selection for a first machine-learning model using feature interactions from a preliminary feature set used for a second model, in accordance with one or more embodiments.

FIG. 2 shows the process of augmenting feature selection for a first machine-learning model using feature interactions from a preliminary feature set used for a second model, in accordance with one or more embodiments.

FIG. 3 shows illustrative components for augmenting feature selection for a first machine-learning model using feature interactions from a preliminary feature set used for a second model, in accordance with one or more embodiments.

FIG. 4 shows a flowchart of the steps involved in augmenting feature selection for a first machine-learning model using feature interactions from a preliminary feature set used for a second model, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

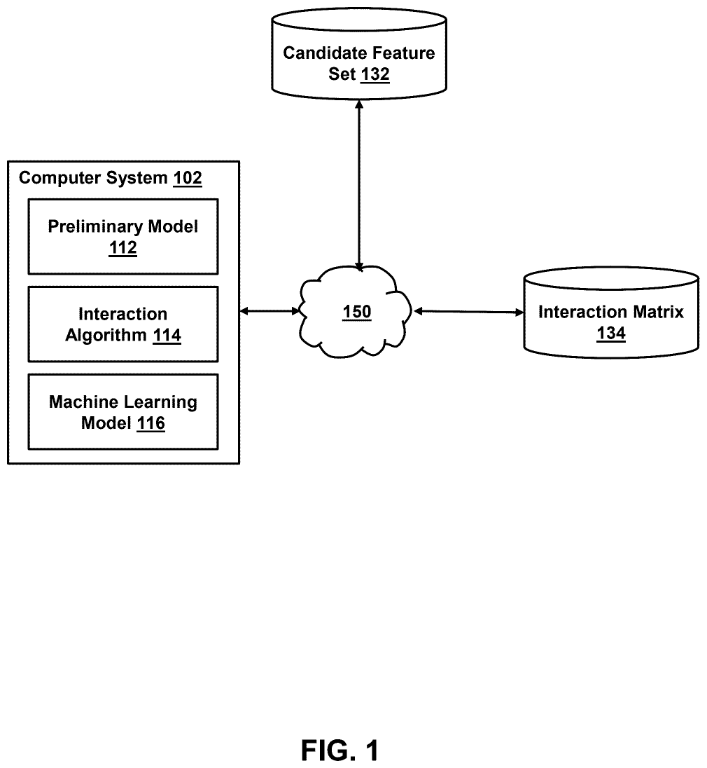

FIG. 1 shows an illustrative diagram for system 150, which contains hardware and software components used to perform feature selection based on interactions with precursor features, in accordance with one or more embodiments. For example, Computer System 102, a part of system 150, may include Preliminary Model 112, Interaction Algorithm 114, and Machine Learning Model 116. System 150 may create, store, or otherwise interact with elements such as Candidate Feature Set 132 and Interaction Matrix 134.

The system may be deployed to a multi-stage model development pipeline for creating and fine-tuning a series of machine learning models which may be iterations of models aimed at producing the same output with increasing levels of accuracy or performing sequential prediction where the output of an upstream model is used by a downstream model. Due to the different nature of models at various stages, features used by a prior model may not be immediately applicable to a later model. For example, the later model may use a different algorithm, or may be trained to predict an entirely different class of outcomes. Therefore, the feature selection performed at an earlier stage is not directly usable by a later stage. In some embodiments, additional data security or confidentiality concerns may prevent the use of previous feature sets or training data.

System 150 may train a preliminary machine learning model (e.g., Preliminary Model 112) at a stage in the model development pipeline. Preliminary Model 112 may be trained using a precursor feature set. The precursor feature set may be selected from a range of possible features by the system in a feature selection process and may aid in enhancing the performance of Preliminary Model 112. The system may, for example, select for features with the greatest correlation to the output of Preliminary Model 112 using a variety of explainability techniques to generate the precursor feature set. Preliminary Model 112 may be trained using the gradient descent or backpropagation parameter tuning method and may be evaluated on a loss function assessing adherence to the training dataset. In some embodiments, Preliminary Model 112 may be trained in an unsupervised or semi-supervised learning scheme to, for example, perform quantitative prediction. Preliminary Model 112 may be trained to perform a task that is adjacent to or the same as that performed by Machine Learning Model 116. For example, Preliminary Model 112 may be used to calculate a default probability for a line of credit. Machine Learning Model 116 may then be used to generate a proposed interest rate only if the output of Preliminary Model 112 satisfies a risk requirement. In another example, Preliminary Model 112 may be used to generate a preliminary estimate for cloud resource usage in a period of time. Machine Learning Model 116 may be used to generate a second, more accurate estimate. The difference may be that Preliminary Model 112 uses a smaller set of features and is therefore a leaner model capable of faster computation. Machine Learning Model 116 may use a more complete set of features and the system may thus lend more confidence to its forecasts. In some embodiments, the features used by Preliminary Model 112 may be used to inform feature selection for Machine Learning Model 116 due to the related nature of these models. In some embodiments, the training data for Preliminary Model 112 may not be directly applicable for Machine Learning Model 116, so the following feature selection process is used as an alternative means of leveraging the training and feature selection of Preliminary Model 112 for Machine Learning Model 116.

The system may receive training data containing a candidate set of features, which may be used as input by a machine learning model (e.g., Machine Learning Model 116). The training data may be, for example, resource consumption data in a time-series format. For example, Machine Learning Model 116 may be trained to predict resource consumption at a future point in time. The training data may, for example, include quantitative or categorical variables related to resource consumption. The candidate set of features may include any set of variables in the training data that the system deems relevant to the functioning of Machine Learning Model 116 in any way. The training data may be a raw dataset not yet subjected to feature selection. The system may choose the candidate set of features to be comprehensive, but may not select for the most effective features. If Machine Learning Model 116 is trained with the entirety of the candidate set of features, the model is likely encumbered by unnecessary computations, and may lead to sub-optimal prediction results due to excess features acting as confounding factors.

The system may apply data cleansing to the precursor feature set and/or Candidate Feature Set 132. The data cleansing process may include removing outliers, standardizing data types, formatting and units of measurement, and removing duplicate data. For example, if the precursor feature set and Candidate Feature Set 132 use different units of measurement, the system may apply a conversion based on mathematical transformations of some or all of the features.

The system determines a covariance matrix based on the precursor feature set and Candidate Feature Set 132. The covariance matrix may, for example, be based on mathematical correlations between the precursor feature set and Candidate Feature Set 132. The system may compute correlation coefficients between each feature in the precursor feature set or Candidate Feature Set 132 and each other feature. The system may use a correlation algorithm such as Pearson correlation algorithms, principal component analysis or Point-Biserial correlation.

The system extracts a second set of features from the covariance matrix. For example, the system may select features with values in the covariance matrix below a threshold. This is to prevent cross-correlations between features, which reduces the predictive accuracy of models trained on such features. Additionally, the system may select features from the covariance matrix based on data attributes or categories. For example, the system may be restricted by feature type requirements in selecting features for Machine Learning Model 116. Machine Learning Model 116 may only use quantitative variables due to the nature of the algorithm, for example. Additionally or alternatively, the system may remove certain features from consideration due to confidentiality requirements to generate a formatted feature set.

The system (e.g., Interaction Algorithm 114) may produce an interaction matrix (e.g., Interaction Matrix 134) based on the second set of features. The system may do so by training an algorithm on the second set of features, the algorithm being configured to perform the same prediction tasks as Machine Learning Model 116. The interaction matrix contains real values for each pair of features, the value indicating the explanative power of the two features for generating the output of the algorithm. For example, the algorithm may derive more predictive power from using two features in conjunction than the sum of their individual predictive effectiveness. Additionally, the interaction represents how each feature correlates to the output of the algorithm and the causative effect of each feature in producing the output as construed by the model. The system may, in some embodiments, produce interaction matrices containing values for any selection of features. For example, the system may select sets of three features, and the value represents the additive explanative effects of using all three in conjunction. For example, the algorithm may use an ensemble of decision trees in an XG-Boost gradient-boosting architecture. The algorithm may train a plurality of decision trees, each tree with a depth parameter equal to the number of features being tested for interaction. For example, a decision tree with two layers would be suitable to test for interaction between two features, because each layer represents a feature and the system may extract node-level statistics to indicate an interaction strength.

In another example, the algorithm may contain a matrix of weights for a multivariate regression algorithm. Interaction Algorithm 114 may use a Shapley Additive Explanation method to extract Interaction Matrix 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. The interaction matrix may be a matrix of normalized Shapley values of each feature.

In another example, the algorithm may contain a vector of coefficients for a generalized additive model. Since the nature of generalized additive models is such that the effect of each variable on the output is completely and independently captured by its coefficient, The system may take the list of coefficients to be the interaction matrix.

In another example, the algorithm may contain a matrix of weights for a supervised classifier algorithm. The system may use a Local Interpretable Model-agnostic Explanations method to extract the interaction matrix. The Local Interpretable Model-agnostic Explanations approximates the results of the algorithm with an explainable model, e.g., a decision tree classifier. In some embodiments, the number of variables that the approximate model uses can be specified. The approximate model will clearly define the effect of each feature on the output: for example, the approximate model may be a generalized additive model.

In another example, the algorithm may contain a matrix of weights for a convolutional neural network algorithm. The system may use a Gradient Class Activation Mapping method to extract the interaction matrix. The Grad-CAM technique performs backpropagation on the output of the model with respect to the final convolutional feature map to compute derivatives of features in the input with respect to the output of the model. The derivatives may then be used as indications of importance of features to a model, and the interaction matrix may be a list of such derivatives.

In another example, the algorithm may contain a set of parameters comprising a hyperplane matrix for a support vector machine algorithm. The system may use a counterfactual explanation method to extract the interaction matrix. The counterfactual explanation method looks for input data which are identical or extremely close in values for all features except one. Then the difference in prediction results may be divided by the difference in the divergent value. This process is repeated on each feature for all pairs of available input vectors, and the aggregated result is a measure for the effect of each feature on the output of the model, which may be formed into the interaction matrix.

The system may then select features in the second set of features with values in the interaction matrix above a threshold. In some embodiments, the system may use one or more filtering criteria to adjust the values corresponding to certain features. In some embodiments, these adjustments may be performed in response to a user request. For example, the system may receive a requirement specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. The system may then calculate a threshold for removing features of the interaction matrix. In some embodiments, the threshold may correspond to a pre-set real number, e.g., 0.45. In other embodiments, the system may simply remove the bottom 10% of features ranked by values in the interaction matrix.

The system may train Machine Learning Model 116, using the selected subset of features as input. Machine Learning Model 116 may take as input a vector of feature values for the first set of features and output a resource availability score indicating an amount of resources that should be assigned to a user system with such feature values as the input. Machine Learning Model 116 may use one or more algorithms like linear regression, generalized additive models, artificial neural networks or random forests to achieve quantitative prediction. The system may partition the matrix of user profiles into a training set and a cross-validating set. Using the training set, the system may train Machine Learning Model 116 using, for example, the gradient descent technique. The system may then cross-validate the trained model using the cross-validating set and further fine-tune the parameters of the model. Machine Learning Model 116 may include one or more parameters that it uses to translate input into outputs. For example, an artificial neural network contains a matrix of weights, each weight in which is a real number. The repeated multiplication and combination of weights transform input values to Machine Learning Model 116 into output values.

Machine Learning Model 116 may be deployed in a machine learning model system used to predict user behavior relating to credit usage, for example. Whereas a precursor model such as Preliminary Model 112 may be used to determine grants of loans and other credit vehicles, Machine Learning Model 116 may be used to predict subsequent user behavior. For example, Machine Learning Model 116 may be used to predict the probability of a default for a line of credit, predict lifetime payment of a loan, perform account-level validation, or estimate a charge-off likelihood. Machine Learning Model 116 may, in some embodiments, require further confirmation of its estimates from downstream models.

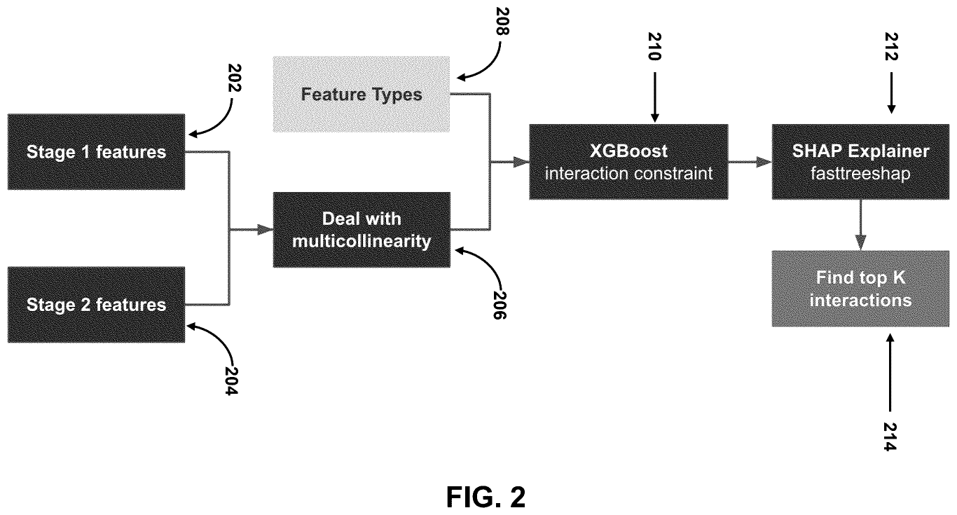

FIG. 2 shows a flow diagram for feature selection based on interactions between multi-stage feature sets. The system may combine a set of features used for a stage 1 model (Feature Set 202) and features for a stage 2 model (Feature Set 204) to a combined set to perform co-linearity reduction. Feature Set 202 may be used for an upstream model whereas Feature Set 204 is used for a downstream model, for example.

Process 206 will extract a second set of features by combining Feature Set 202 and Feature Set 204 and removing highly-correlated features. For example, Process 206 may determine a covariance matrix. The covariance matrix may, for example, be based on mathematical correlations between Feature Set 202 and Feature Set 204. The system may compute correlation coefficients between each feature in Feature Set 202 and Feature Set 204 and each other feature. The system may use a correlation algorithm such as Pearson correlation algorithms, principal component analysis or Point-Biserial correlation.

Simultaneously, Process 208 may impose a feature type requirement to eliminate certain features from the second set of features. Process 208 may, for example, impose confidentiality requirements on Feature Set 202 or 204. Process 208 may aim to satisfy a requirement specifying that a subset of features be removed from consideration. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. In other examples, Process 208 may remove features from 202 or 204 that are unsuitable for the final machine learning model. For example, categorical features may be removed from consideration for a multivariate regression algorithm.

Process 210 may train a series of decision trees using an XGBoost architecture. Process 210 may train a plurality of decision trees, each tree with a depth parameter equal to the number of features being tested for interaction. For example, Process 210 may train an ensemble of decision trees with two layers, one tree in the ensemble for each pair of features. Each tree may be configured to produce predictions for the output of the machine learning model. Due to the setup of the XGBoost algorithm, each tree may measure the predictive power of its component features, and may additionally reveal the additive effect in explanative power for using each pair of features in conjunction. In this way, Process 210 can capture the interaction strength between any feature and any other feature.

Process 212 uses a Shapley explanation method to extract feature power metrics corresponding to each feature and/or pair of features. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. For example, Process 212 may extract node-level statistics for each tree in the ensemble of decision trees, the statistics corresponding to Shapley values indicating the explanative power of features for producing the output of the model.

Process 214 selects a set of final features based on interaction values. The system may then calculate a threshold for removing features in the second set of features. In some embodiments, the threshold may correspond to a pre-set real number, e.g., 0.45. In other embodiments, the system may simply remove the bottom 10% of features ranked by interaction values. Using this final set of features, the system may train a lean machine learning model to perform prediction with greater accuracy and computational expedience.

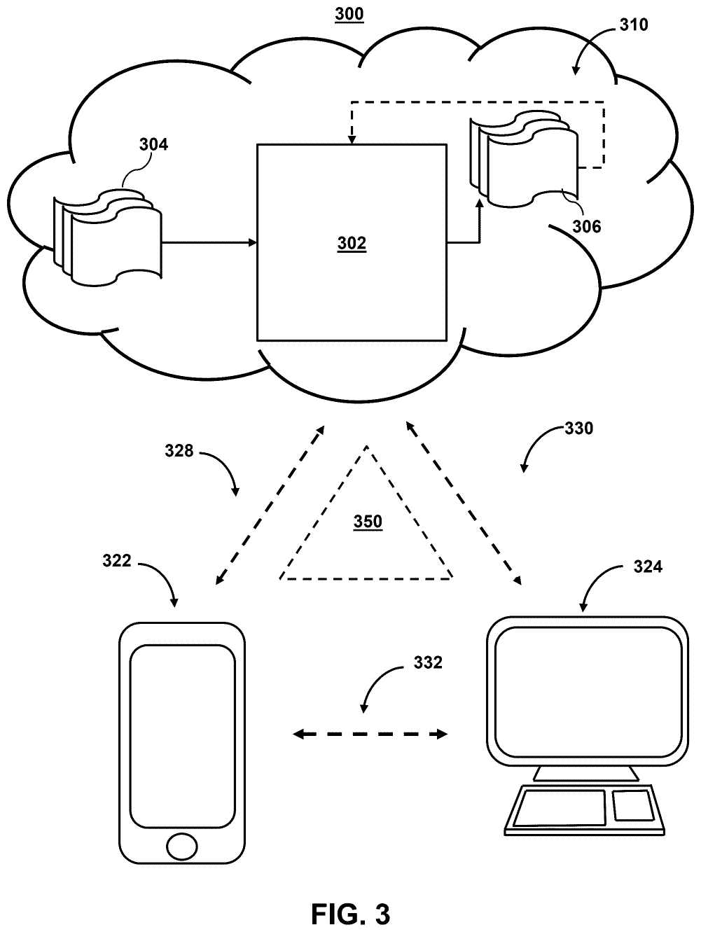

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., the output predictions of one or more machine learning models).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction. For example, model 302 may be used to label credit applications, in much the same way as Machine Learning Model 116.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., classifying a credit application into categories of default risk).

In some embodiments, the model (e.g., model 302) may automatically perform actions based on outputs 306. In some embodiments, the model (e.g., model 302) may not perform any actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

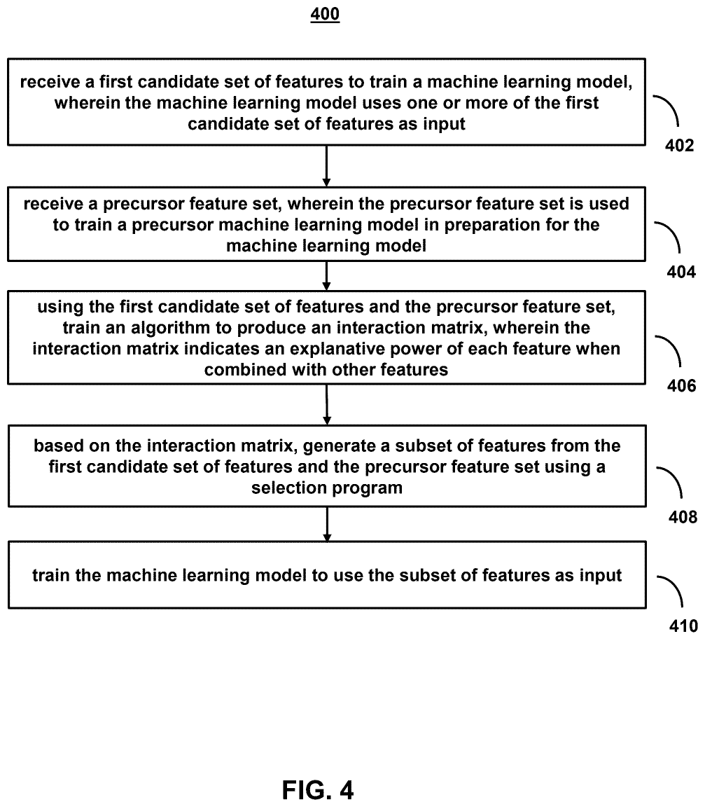

FIG. 4 shows a flowchart of the steps involved in augmenting feature selection for a first machine-learning model using feature interactions from a preliminary feature set used for a second model, in accordance with one or more embodiments.

At step 402, process 400 (e.g., using one or more components described above) receives a first candidate set of features to train a machine learning model, wherein the machine learning model uses one or more of the first candidate set of features as input. The system may receive training data containing a candidate set of features, which may be used as input by a machine learning model (e.g., Machine Learning Model 116). The training data may be, for example, resource consumption data in a time-series format. For example, Machine Learning Model 116 may be trained to predict resource consumption at a future point in time. The training data may, for example, include quantitative or categorical variables related to resource consumption. The candidate set of features may include any set of variables in the training data that the system deems relevant to the functioning of Machine Learning Model 116 in any way. The training data may be a raw dataset not yet subjected to feature selection. The system may choose the candidate set of features to be comprehensive, but may not select for the most effective features. If Machine Learning Model 116 is trained with the entirety of the candidate set of features, the model is likely encumbered by unnecessary computations, and may lead to sub-optimal prediction results due to excess features acting as confounding factors.

The system may apply data cleansing to the precursor feature set and/or Candidate Feature Set 132. The data cleansing process may include removing outliers, standardizing data types, formatting and units of measurement, and removing duplicate data. For example, if the precursor feature set and Candidate Feature Set 132 use different units of measurement, the system may apply a conversion based on mathematical transformations of some or all of the features.

At step 404, process 400 (e.g., using one or more components described above) receives a precursor feature set, wherein the precursor feature set is used to train a precursor machine learning model in preparation for the machine learning model. The system may train a preliminary machine learning model (e.g., Preliminary Model 112) at a stage in the model development pipeline. Preliminary Model 112 may be trained using a precursor feature set. The precursor feature set may be selected from a range of possible features by the system in a feature selection process and may aid in enhancing the performance of Preliminary Model 112. The system may, for example, select for features with the greatest correlation to the output of Preliminary Model 112 using a variety of explainability techniques to generate the precursor feature set. Preliminary Model 112 may be trained using the gradient descent or backpropagation parameter tuning method and may be evaluated on a loss function assessing adherence to the training dataset. In some embodiments, Preliminary Model 112 may be trained in an unsupervised or semi-supervised learning scheme to, for example, perform quantitative prediction. Preliminary Model 112 may be trained to perform a task that is adjacent to or the same as that performed by Machine Learning Model 116. For example, Preliminary Model 112 may be used to calculate a default probability for a line of credit. Machine Learning Model 116 may then be used to generate a proposed interest rate only if the output of Preliminary Model 112 satisfies a risk requirement. In another example, Preliminary Model 112 may be used to generate a preliminary estimate for cloud resource usage in a period of time. Machine Learning Model 116 may be used to generate a second, more accurate estimate. The difference may be that Preliminary Model 112 uses a smaller set of features and is therefore a leaner model capable of faster computation. Machine Learning Model 116 may use a more complete set of features and the system may thus lend more confidence to its forecasts. In some embodiments, the features used by Preliminary Model 112 may be used to inform feature selection for Machine Learning Model 116 due to the related nature of these models. In some embodiments, the training data for Preliminary Model 112 may not be directly applicable for Machine Learning Model 116, so the following feature selection process is used as an alternative means of leveraging the training and feature selection of Preliminary Model 112 for Machine Learning Model 116.

At step 406, process 400 (e.g., using one or more components described above) trains an algorithm using the first candidate set of features and the precursor feature set to produce an interaction matrix, wherein the interaction matrix indicates an explanative power of each feature when combined with other features. The system (e.g., Interaction Subsystem 114) may produce an interaction matrix (e.g., Interaction Matrix 134) based on the second set of features. The system may do so by training an algorithm on the second set of features, the algorithm being configured to perform the same prediction tasks as Machine Learning Model 116. The interaction matrix contains real values for each pair of features, the value indicating the explanative power of the two features for generating the output of the algorithm. For example, the algorithm may derive more predictive power from using two features in conjunction than the sum of their individual predictive effectiveness. Additionally, the interaction represents how each feature correlates to the output of the algorithm and the causative effect of each feature in producing the output as construed by the model. The system may, in some embodiments, produce interaction matrices containing values for any selection of features. For example, the system may select sets of three features, and the value represents the additive explanative effects of using all three in conjunction.

For example, the algorithm may use an ensemble of decision trees in an XG-Boost gradient-boosting architecture. The algorithm may train a plurality of decision trees, each tree with a depth parameter equal to the number of features being tested for interaction. For example, a decision tree with two layers would be suitable to test for interaction between two features, because each layer represents a feature and the system may extract node-level statistics to indicate an interaction strength.

In another example, the algorithm may contain a matrix of weights for a multivariate regression algorithm. Interaction Algorithm 114 may use a Shapley Additive Explanation method to extract Interaction Matrix 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. The interaction matrix may be a matrix of normalized Shapley values of each feature.

In another example, the algorithm may contain a vector of coefficients for a generalized additive model. Since the nature of generalized additive models is such that the effect of each variable on the output is completely and independently captured by its coefficient, The system may take the list of coefficients to be the interaction matrix.

In another example, the algorithm may contain a matrix of weights for a supervised classifier algorithm. The system may use a Local Interpretable Model-agnostic Explanations method to extract the interaction matrix. The Local Interpretable Model-agnostic Explanations approximates the results of the algorithm with an explainable model, e.g., a decision tree classifier. In some embodiments, the number of variables that the approximate model uses can be specified. The approximate model will clearly define the effect of each feature on the output: for example, the approximate model may be a generalized additive model.

In another example, the algorithm may contain a matrix of weights for a convolutional neural network algorithm. The system may use a Gradient Class Activation Mapping method to extract the interaction matrix. The Grad-CAM technique performs backpropagation on the output of the model with respect to the final convolutional feature map to compute derivatives of features in the input with respect to the output of the model. The derivatives may then be used as indications of importance of features to a model, and the interaction matrix may be a list of such derivatives.

In another example, the algorithm may contain a set of parameters comprising a hyperplane matrix for a support vector machine algorithm. The system may use a counterfactual explanation method to extract the interaction matrix. The counterfactual explanation method looks for input data which are identical or extremely close in values for all features except one. Then the difference in prediction results may be divided by the difference in the divergent value. This process is repeated on each feature for all pairs of available input vectors, and the aggregated result is a measure for the effect of each feature on the output of the model, which may be formed into the interaction matrix.

At step 408, process 400 (e.g., using one or more components described above) generates a subset of features from the first candidate set of features and the precursor feature set using a selection program. The system may select features in the second set of features with values in the interaction matrix above a threshold. In some embodiments, the system may use one or more filtering criteria to adjust the values corresponding to certain features. In some embodiments, these adjustments may be performed in response to a user request. For example, the system may receive a requirement specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. The system may then calculate a threshold for removing features of the interaction matrix. In some embodiments, the threshold may correspond to a pre-set real number, e.g., 0.45. In other embodiments, the system may simply remove the bottom 10% of features ranked by values in the interaction matrix.

At step 410, process 400 (e.g., using one or more components described above) trains the machine learning model to use the subset of features as input. The system may train Machine Learning Model 116, using the selected subset of features as input. Machine Learning Model 116 may take as input a vector of feature values for the first set of features and output a resource availability score indicating an amount of resources that should be assigned to a user system with such feature values as the input. Resource Availability Model 112 may use one or more algorithms like linear regression, generalized additive models, artificial neural networks or random forests to achieve quantitative prediction. The system may partition the matrix of user profiles into a training set and a cross-validating set. Using the training set, the system may train Resource Availability Model 112 using, for example, the gradient descent technique. The system may then cross-validate the trained model using the cross-validating set and further fine-tune the parameters of the model. Resource Availability Model 112 may include one or more parameters that it uses to translate input into outputs. For example, an artificial neural network contains a matrix of weights, each weight in which is a real number. The repeated multiplication and combination of weights transform input values to Resource Availability Model 112 into output values.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for augmenting feature selection for a first machine learning model using feature interactions from a preliminary feature set used for a second model, comprising: receiving a candidate set of features to train a machine learning model, wherein the machine learning model uses one or more of the candidate set of features as input; receiving a precursor feature set, wherein the precursor feature set is used to train a precursor machine learning model in preparation for the machine learning model; using a data cleansing process, generating a formatted feature set based on the precursor feature set; using a correlation algorithm, determining a covariance matrix based on the candidate set of features and the formatted feature set, wherein the covariance matrix indicates correlations between feature values for each pair of features within the candidate set of features and the precursor feature set; determining a second set of features based on the covariance matrix, wherein the second set of features includes features from first set of features and the formatted feature set whose values in the covariance matrix fall below a first threshold; using the second set of features, training an XGBoost algorithm to produce an interaction matrix, wherein the interaction matrix indicates an explanative power of each feature in the second set of features when combined with other features; generating a subset of features by selecting features from the second set of features with values in the interaction matrix above a second threshold; and training the machine learning model to use the subset of features as input.
2. A method for augmenting feature selection for a first machine learning model using feature interactions from a preliminary feature set used for a second model, comprising: receiving a first candidate set of features to train a machine learning model, wherein the machine learning model uses one or more of the first candidate set of features as input; receiving a precursor feature set, wherein the precursor feature set is used to train a precursor machine learning model in preparation for the machine learning model; using the first candidate set of features and the precursor feature set, training an algorithm to produce an interaction matrix, wherein the interaction matrix indicates an explanative power of each feature when combined with other features; based on the interaction matrix, generating a subset of features from the first candidate set of features and the precursor feature set using a selection program; and training the machine learning model to use the subset of features as input.
3. A method comprising: receiving a first candidate set of features to train a machine learning model, wherein the machine learning model uses one or more of the first candidate set of features as input; receiving a precursor feature set, wherein the precursor feature set is used to train a precursor machine learning model in preparation for the machine learning model; using a correlation algorithm, determining a covariance matrix based on the first candidate set of features and the precursor feature set, wherein the covariance matrix indicates degrees of correlation between any pair of features; and determining a formatted feature set based on the covariance matrix, comprising selections from the first candidate set of features and the precursor feature set; using the formatted feature set, training an algorithm to produce an interaction matrix, wherein the interaction matrix indicates an explanative power of each feature when combined with other features; based on the interaction matrix, generating a subset of features from the first candidate set of features and the precursor feature set using a selection program; and training the machine learning model to use the subset of features as input.
4. The method of any one of the preceding embodiments, further comprising preliminary feature selection by generating a formatted feature set, comprising: using a correlation algorithm, determining a covariance matrix based on the first candidate set of features and the precursor feature set, wherein the covariance matrix indicates degrees of correlation between any pair of features; and determining a formatted feature set based on the covariance matrix, comprising selections from the first candidate set of features and the precursor feature set based on values in the covariance matrix below a threshold.
5. The method of any one of the preceding embodiments, wherein determining the covariance matrix comprises: retrieving a candidate dataset, comprising values for the first candidate set of features; retrieving a precursor dataset, which is used to train the precursor machine learning model; and using a data analytic technique to calculate the covariance matrix based on the candidate dataset and the precursor dataset.
6. The method of any one of the preceding embodiments, wherein producing the interaction matrix comprises: training a first ensemble of decision trees based on an XGBoost algorithm, wherein the decision trees have a specified depth representing features being measured for interaction; generating an explanative database by extracting parameters and metrics from each decision tree in the first ensemble of decision trees; and generating the interaction matrix based on the explanative database, wherein the interaction matrix contains real values indicating additive increases to predictive power between pairs of features.
7. The method of any one of the preceding embodiments, further comprising updating the interaction matrix, comprising: generating a second ensemble of decision trees, wherein the second ensemble contains trees of different depth than the first ensemble; updating the explanative database based on the parameters and metrics of the second ensemble; and updating the interaction matrix based on the updated explanative database.
8. The method of any one of the preceding embodiments, wherein the selection program generates the subset of features by: using parameters of the algorithm and the interaction matrix, generating a model weight vector; and selecting the subset of features with highest values in the model weight vector above.
9. The method of any one of the preceding embodiments, wherein: the algorithm is defined by a set of linear pairwise-interaction models; and the model weight vector is extracted from coefficients of the set of linear pairwise-interaction models.
10. The method of any one of the preceding embodiments, wherein: the algorithm is defined by a set of parameters comprising a matrix of weights for a multivariate regression algorithm; and the model weight vector is extracted from the set of parameters and the interaction matrix using a Shapley Additive method.
11. The method of any one of the preceding embodiments, wherein: the algorithm is defined by a set of parameters comprising a matrix of weights for a supervised classifier algorithm; and the model weight vector is extracted from the set of parameters and the interaction matrix using a Local Interpretable Model-agnostic method.
12. The method of any one of the preceding embodiments, wherein: the algorithm is defined by a set of parameters comprising a vector of coefficients for a generalized additive model; and the model weight vector is extracted from the vector of coefficients in the generalized additive model and the interaction matrix.
13. One or more non-transitory computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for augmenting feature selection for a first machine learning model using feature interactions from a preliminary feature set used for a second model, comprising:
one or more processors; and
one or more non-transitory, computer-readable media comprising instructions that, when executed by the one or more processors, cause operations comprising:
receiving a candidate set of features to train a machine learning model, wherein the machine learning model uses one or more of the candidate set of features as input;
receiving a precursor feature set, wherein the precursor feature set is used to train a precursor machine learning model in preparation for the machine learning model;
using a data cleansing process, generating a formatted feature set based on the precursor feature set;
using a correlation algorithm, determining a covariance matrix based on the candidate set of features and the formatted feature set, wherein the covariance matrix indicates correlations between feature values for each pair of features within the candidate set of features and the precursor feature set;
determining a second set of features based on the covariance matrix, wherein the second set of features includes features from first set of features and the formatted feature set whose values in the covariance matrix fall below a first threshold;
using the second set of features, training an XGBoost algorithm to produce an interaction matrix, wherein the interaction matrix indicates an explanative power of each feature in the second set of features when combined with other features;
generating a subset of features by selecting features from the second set of features with values in the interaction matrix above a second threshold; and
training the machine learning model to use the subset of features as input.

2. A method for augmenting feature selection for a first machine learning model using feature interactions from a preliminary feature set used for a second model, comprising:
receiving a first candidate set of features to train a machine learning model, wherein the machine learning model uses one or more of the first candidate set of features as input;
receiving a precursor feature set, wherein the precursor feature set is used to train a precursor machine learning model in preparation for the machine learning model;
using the first candidate set of features and the precursor feature set, training an algorithm to produce an interaction matrix, wherein the interaction matrix indicates an explanative power of each feature when combined with other features;
based on the interaction matrix, generating a subset of features from the first candidate set of features and the precursor feature set using a selection program; and
training the machine learning model to use the subset of features as input.

3. The method of claim 2, further comprising preliminary feature selection by generating a formatted feature set, comprising:
using a correlation algorithm, determining a covariance matrix based on the first candidate set of features and the precursor feature set, wherein the covariance matrix indicates degrees of correlation between any pair of features; and
determining a formatted feature set based on the covariance matrix, comprising selections from the first candidate set of features and the precursor feature set based on values in the covariance matrix below a threshold.

4. The method of claim 3, wherein determining the covariance matrix comprises:
retrieving a candidate dataset, comprising values for the first candidate set of features;
retrieving a precursor dataset, which is used to train the precursor machine learning model; and
using a data analytic technique to calculate the covariance matrix based on the candidate dataset and the precursor dataset.

5. The method of claim 2, wherein producing the interaction matrix comprises:
training a first ensemble of decision trees based on an XGBoost algorithm, wherein the decision trees have a specified depth representing features being measured for interaction;
generating an explanative database by extracting parameters and metrics from each decision tree in the first ensemble of decision trees; and
generating the interaction matrix based on the explanative database, wherein the interaction matrix contains real values indicating additive increases to predictive power between pairs of features.

6. The method of claim 5, further comprising updating the interaction matrix, comprising:
generating a second ensemble of decision trees, wherein the second ensemble contains trees of different depth than the first ensemble;
updating the explanative database based on the parameters and metrics of the second ensemble; and
updating the interaction matrix based on the updated explanative database.

7. The method of claim 2, wherein the selection program generates the subset of features by:
using parameters of the algorithm and the interaction matrix, generating a model weight vector; and
selecting the subset of features with highest values in the model weight vector above.

8. The method of claim 7, wherein:
the algorithm is defined by a set of linear pairwise-interaction models; and
the model weight vector is extracted from coefficients of the set of linear pairwise-interaction models.

9. The method of claim 7, wherein:
the algorithm is defined by a set of parameters comprising a matrix of weights for a multivariate regression algorithm; and
the model weight vector is extracted from the set of parameters and the interaction matrix using a Shapley Additive method.

10. The method of claim 7, wherein:
the algorithm is defined by a set of parameters comprising a matrix of weights for a supervised classifier algorithm; and
the model weight vector is extracted from the set of parameters and the interaction matrix using a Local Interpretable Model-agnostic method.

11. The method of claim 7, wherein:
the algorithm is defined by a set of parameters comprising a vector of coefficients for a generalized additive model; and
the model weight vector is extracted from the vector of coefficients in the generalized additive model and the interaction matrix.

12. One or more non-transitory computer-readable media comprising instructions that, when executed by one or more processors, cause operations comprising:
receiving a first candidate set of features to train a machine learning model, wherein the machine learning model uses one or more of the first candidate set of features as input;
receiving a precursor feature set, wherein the precursor feature set is used to train a precursor machine learning model in preparation for the machine learning model;
using a correlation algorithm, determining a covariance matrix based on the first candidate set of features and the precursor feature set, wherein the covariance matrix indicates degrees of correlation between any pair of features; and
determining a formatted feature set based on the covariance matrix, comprising selections from the first candidate set of features and the precursor feature set;
using the formatted feature set, training an algorithm to produce an interaction matrix, wherein the interaction matrix indicates an explanative power of each feature when combined with other features;
based on the interaction matrix, generating a subset of features from the first candidate set of features and the precursor feature set using a selection program; and
training the machine learning model to use the subset of features as input.

13. The one or more non-transitory computer-readable media of claim 12, wherein determining the covariance matrix comprises:
retrieving a candidate dataset, comprising values for the candidate set of features;
retrieving a precursor dataset, which is used to train the precursor machine learning model; and
using a data analytic technique to calculate the covariance matrix based on the candidate dataset and the precursor dataset.

14. The one or more non-transitory computer-readable media of claim 12, wherein producing the interaction matrix comprises:
training an ensemble of decision trees based on an XGBoost algorithm, wherein the decision trees have a specified depth representing features being measured for interaction;
generating an explanative database by extracting parameters and metrics from each decision tree in the ensemble of decision trees; and
generating the interaction matrix based on the explanative database, wherein the interaction matrix contains real values indicating additive increases to predictive power between pairs of features.

15. The one or more non-transitory computer-readable media of claim 14, wherein the operations further comprise updating the interaction matrix, comprising:
generating a second ensemble of decision trees, wherein the second ensemble contains trees of different depth than the first;
updating the explanative database based on the parameters and metrics of the second ensemble; and
updating the interaction matrix based on the updated explanative database.

16. The one or more non-transitory computer-readable media of claim 12, wherein the formatted set of features comprises features in the first candidate set of features and the precursor feature set with correlation values in the covariance matrix below a threshold.

17. The one or more non-transitory computer-readable media of claim 12, wherein the selection program generates the subset of features by:
using parameters of the algorithm and the interaction matrix, generating a model weight vector; and
selecting the subset of features to be features with highest values in the model weight vector above.

18. The one or more non-transitory computer-readable media of claim 17, wherein:
the algorithm is defined by a set of parameters comprising a matrix of weights for a multivariate regression algorithm; and
the model weight vector is extracted from the set of parameters and the interaction matrix using a Shapley Additive method.

19. The one or more non-transitory computer-readable media of claim 17, wherein:
the algorithm is defined by a set of parameters comprising a matrix of weights for a supervised classifier algorithm; and
the model weight vector is extracted from the set of parameters and the interaction matrix using a Local Interpretable Model-agnostic method.

20. The one or more non-transitory computer-readable media of claim 17, wherein:
the algorithm is defined by a set of linear pairwise-interaction models; and
the model weight vector is extracted from coefficients of the set of linear pairwise-interaction models.
